(19) United States
(12) Patent Application Publication
(10) Pub. No.: US 2003/0198478 A1
(43) Pub. Date: Oct. 23, 2003

(54) Method and system for generating and decoding a bandwidth efficient multi-level signal

(75) Inventors: Michael G. Vrazel, Atlanta, GA (US); Stephen E. Ralph, Atlanta, GA (US)

Correspondence Address: KING & SPALDING, 191 PEACHTREE STREET, N.E., ATLANTA, GA, 30303-1763, US

(73) Assignee: Quellan, Inc., Atlanta, GA

(21) Appl. No.: 10/423,524

(22) Filed: Apr. 23, 2003

Related U.S. Application Data
(60) Provisional application No. 60/374,649, filed on Apr. 23, 2002.

(51) Int. Cl. H04B 10/04

(52) U.S. Cl. 398/183

(57) ABSTRACT

The present invention combines standard binary ASK modulation with differential PSK (DPSK) modulation to achieve a two times or doubled increase in data throughput and a spectral efficiency of 1 bit/s/Hz. In other words, the present invention can be characterized as overlaying DPSK onto a regular binary ASK transmission. Each bit generated by the inventive modulation technique can have one of two intensities and one of two phases such that every symbol transmitted can comprise two bits. The present invention encodes (and subsequently decodes) information into both the phase and amplitude of a carrier signal. This translates into less complex circuitry and lower costs for a receiver in the inventive system. This also means that phase integrity does not need to be maintained throughout the communications system like that of a coherent QAM communications system because the relative phase instead of the absolute phase is tracked.

### STATEMENT REGARDING RELATED APPLICATIONS

The present application claims priority to a provisional patent application entitled, “Combination of ASK and DPSK for Increased Throughput in an Optical Communications Link,” filed on Apr. 23, 2002 and assigned U.S. Application Serial No. 60/374,649. The contents of the provisional patent application are hereby incorporated by reference.

### TECHNICAL FIELD

The present invention relates to data communications. More particularly, the present invention relates to a method and system for producing a multilevel signal using a unique combination of amplitude and phase modulation that can be employed in both radio frequency (RF) and optical links.

### BACKGROUND OF THE INVENTION

Standard high-speed on-off keyed (OOK) optical links operate with a low spectral efficiency (defined as aggregate throughput over total bandwidth). For example, significant efforts are required to achieve a spectral efficiency of 0.5 bit/s/Hz. The primary advantage of deploying high spectral efficiency links is the reduced channel count and the associated reduction in complexity and cost. Furthermore, the reduced spectral requirements of a specific data rate allow a reduced sensitivity to dispersion.

One technique for increasing spectral efficiency or bandwidth is duobinary signaling. According to this signaling technique, a balanced Mach-Zehnder modulator is used. Specifically, the Mach-Zehnder modulator is driven differentially where the phase of the optical signal is manipulated to compress the spectrum. With the duobinary technique, no information is transmitted in the phase of the optical carrier.

Multilevel modulation also increases spectral efficiency of an optical transmission system. Multi-level modulation refers to modulation schemes which use more than the two levels found in binary schemes. n-ary amplitude shift keying (ASK) and n-ary phase shift keying (PSK) are two conventional multilevel modulation techniques that can increase the spectral efficiency of an optical transmission system to 0.5·n bit/s/Hz. However, each method has notable drawbacks. n-ary ASK incurs a significant optical signal-to-noise ratio (OSNR) penalty at the receiver as n increases. n-ary PSK is not as susceptible to this penalty; however, PSK modulation requires coherent detection at the receiver and is highly susceptible to laser phase noise.

In general, both amplitude and phase modulation are permitted, and the possible symbol values are often depicted in corresponding constellation diagrams. It was recognized that these modulation schemes can be thought of as combinations of two amplitude modulated carriers with orthogonal carrier frequencies hence the name Quadrature Amplitude Modulation (QAM).

Referring briefly to FIG. 1, this Figure illustrates a constellation diagram 100 that depicts both the amplitude and the phase of an allowed set of transmitted symbols for the conventional QAM format. Specifically, 32-QAM is illustrated in FIG. 1 where the I-axis represents in-phase and the Q-axis represents quadrature.

A significant motivation for implementing a multilevel modulation scheme has been the increased data rate achievable for a given modulation rate, thereby improving the spectral efficiency. The lower symbol rates are advantageous for bandwidth-limited channels and also permit the use of components with speeds lower than the aggregate data rate. An increased data rate from these conventional formats usually requires an enhanced signal to noise ratio and much has been reported regarding the optimum constellation format with respect to noise considerations.

Generally, it is advantageous that allowed symbol states as depicted in the constellation are each equally and maximally distant. Importantly, the “optimum” system must also include the practicalities of implementing the various schemes. As data rates increase beyond the 1 Gb/s rate, the implementation becomes even more critical to the successful deployment of such schemes. At higher data rates, and in particular, for optical channels, the increased SNR requirement together with the difficulty in implementing even a modest number of levels has prevented deployment of multilevel optical links.

Referring briefly now to FIG. 2A, this Figure illustrates a constellation diagram 200 of a conventional amplitude and phase modulation format with four possible states, or levels. More specifically, this Figure illustrates a conventional four level scheme implemented exclusively with phase modulation which is generally referred to as multi-level PSK. The conventional four-level constellation diagram 200 allows one amplitude and four phases.

Referring now to FIG. 2B, this Figure illustrates a conventional QPSK transmitter corresponding to the constellation shown in FIG. 2A. An input serial digital data stream, D₁, is split into two parallel data streams with a serial to parallel converter 205, the in-phase and quadrature data streams. Each of the two data streams is low-pass filtered with filters 210 and then used to modulate one of two orthogonal carriers. As shown in FIG. 2A, the two orthogonal carriers are typically generated via a single local oscillator 215 with a 90° phase shifter 220 for the quadrature bits. The two modulated carriers are then summed and band-pass filtered with filter 225 to eliminate any out of band noise.

The output signal is a single QPSK-modulated signal. One of ordinary skill in the art will recognize that differential QPSK could be achieved with the above transmitter embodiment only if D₁ was encoded specifically for DQPSK prior to the serial to parallel converter. In principle, a QAM transmitter could be structured around the embodiment shown in FIG. 2B. For example, 16-QAM could be achieved by adding two 4-bit DACs (not shown) to the transmitter, the first for the in-phase data path (added between the serial to parallel converter 205 and the low pass filter 210) and the second for the quadrature data path (added between the serial to parallel converter 205 and the low pass filter 210).

Referring now to FIG. 2C, this Figure illustrates an exemplary embodiment of a conventional QPSK receiver. The received QPSK signal is first band pass filtered with filter 225 to remove out of band noise acquired in the channel. The signal is then split into two paths in order to recover the in-phase and quadrature bits. Each of these two signals is input to an RF mixer along with the appropriate carrier. In practice, either a local oscillator or oscillator recovery circuit 230 is required to provide the appropriate orthogonal carriers. The outputs of each of the mixers are low pass filtered with filters 210. These signals are used to recover the symbol timing clock with a symbol timing recover circuit 240. The recovered symbol clock is fed to the decision circuitry (threshold detector 520) in each data path in order to recover the digital in-phase and quadrature bit streams. The two bit streams are multiplexed together with a multiplexer 235 to recover the original single digital data stream, D₁. It is straightforward to modify the embodiment illustrated in FIG. 2C to receive QAM signals as opposed to QPSK. The digital threshold detectors would be replaced by 4-bit ADCs (not shown) to enable 16-QAM.

Multilevel PSK is a spectrally efficient conventional modulation technique whereby digital data is encoded into the phase of a carrier wave. In practice, this technique is applicable to carriers in the radio frequency (RF) and optical domains.

Referring to now to FIG. 3, this Figure shows exemplary waveforms for other conventional modulation techniques well known to those skilled in the art. The waveforms D₁, D₂, and D₃ are exemplary input digital data streams. It is well known that these data streams can be combined for improved spectral efficiency using a variety of described methods. Multilevel ASK is illustrated in FIG. 3 (specifically quaternary ASK as determined by D₁+D₂). In this case, the bits in D₁ and D₂ are encoded in the multiple amplitude levels of a single output waveform according to the following truth table:

| D₁ | D₂ | D₁ + D₂ |
|---|---|---|
| 0 | 0 | 0 |
| 1 | 0 | 1 |
| 0 | 1 | 2 |
| 1 | 1 | 3 |

Hence, for the exemplary data streams illustrated in FIG. 3, D₁ and D₂ would be encoded as follows:

| | | | | | | | |
|---|---|---|---|---|---|---|---|
| D₁ | 0 | 1 | 0 | 0 | 1 | 1 | 0 |
| D₂ | 0 | 0 | 1 | 0 | 0 | 1 | 1 |
| D₁ + D₂ | 0 | 1 | 2 | 0 | 1 | 3 | 2 |

Since PSK requires coherent detection to accurately decode the phase information, a preferred and another conventional modulation technique is DPSK, whereby the digital information is encoded into the relative phase changes of the carrier wave. An exemplary quaternary DPSK (QDPSK) waveform is also illustrated in FIG. 3, where the relative phase changes are dependent on the data streams D₁ and D₂ according to the truth table below.

| | | Relative Phase |
|---|---|---|
| D₁ | D₂ | Change |
| 0 | 0 | 0 |
| 1 | 0 | π/2 |
| 0 | 1 | π |
| 1 | 1 | 3π/2 |

Hence, for the exemplary data streams D₁ and D₂ shown in FIG. 3, the exemplary QDPSK waveform is encoded as follows:

| | | | | | | | |
|---|---|---|---|---|---|---|---|
| D₁ | 0 | 1 | 0 | 0 | 1 | 1 | 0 |
| D₂ | 0 | 0 | 1 | 0 | 0 | 1 | 1 |
| Relative Phase Change of the Carrier | 0 | π/2 | π | 0 | π/2 | 3π/2 | π |

Both the QPSK and QDPSK signal formats are described by the constellation diagram 200 of FIG. 2.

As stated, the generalization of ASK and PSK is referred to as quadrature amplitude modulation (QAM), whereby digital information is encoded into the amplitude and phase of a carrier wave (RF or optical). Furthermore, the phase of the carrier can be modulated differentially in a QAM transmitter (similar to the DPSK method described above). 8-ary DQAM constitutes a simple example of differential QAM, whereby three digital bits are encoded into one of eight possible combinations of the phase and amplitude of a carrier (four possible relative phase changes and two possible amplitudes).

The following table summarizes the DQAM encoding method.

| | | | | Relative Phase |
|---|---|---|---|---|
| D₁ | D₂ | D₃ | Amplitude | Change |
| 0 | 0 | 0 | Low | 0 |
| 1 | 0 | 0 | Low | π/2 |
| 0 | 1 | 0 | Low | π |
| 1 | 1 | 0 | Low | 3π/2 |
| 0 | 0 | 1 | High | 0 |
| 1 | 0 | 1 | High | π/2 |
| 0 | 1 | 1 | High | π |
| 1 | 1 | 1 | High | 3π/2 |

Hence, as shown in FIG. 3, the three exemplary digital data streams (D₁, D₂, and D₃) would be combined into a single 8-ary DQAM waveform as follows:

| | | | | | | | |
|---|---|---|---|---|---|---|---|
| D₁ | 0 | 1 | 0 | 0 | 1 | 1 | 0 |
| D₂ | 0 | 0 | 1 | 0 | 0 | 1 | 1 |
| D₃ | 0 | 1 | 1 | 1 | 0 | 1 | 0 |
| Amplitude | Low | High | High | High | Low | High | Low |
| Relative Phase Change | 0 | π/2 | π | 0 | π/2 | 3π/2 | π |

In light of the FIGS. 2 and 3 and the tables above, QAM can be characterized as modulating amplitude and phase of a signal in order to create multiple different discrete states, where each state is defined by some amplitude and some phase. Furthermore, coherent QAM requires the tracking of an absolute phase. The absolute phase of a received signal modulated according to QAM is usually determined by comparing the phase to a reference phase source. The reference phase source of a receiver is usually a local oscillator. A local oscillator adds to the cost as well as the complexity of the receiver circuitry for demodulating QAM signals, particularly in the optical domain where the local oscillator constitutes a laser.

Further, it is very difficult to keep the local oscillator on track with the received phase of a QAM modulated signal. In conventional QAM circuits, the phase and intensity manipulations are typically performed in the electrical domain with a radio frequency carrier prior to converting the QAM signal into the optical domain.

In summary, with coherent QAM, there are two main drawbacks for using this technique to increase spectral efficiency: (1) a full coherent system is needed where phase integrity must be maintained throughout the system, and (2) a local oscillator is needed in the receiver to track some absolute phase of the original transmission. Although differentially encoding the phase information can ease these constraints in the RF domain, multilevel optical phase modulation is difficult to realize without the use of a local optical oscillator at the receiver to de-embed the phase-encoded data. Hence, the chief advantage of differential phase modulation (the lack of need for a local oscillator) cannot be exploited for multilevel optical phase modulation, undercutting any motivation for implementing true optical DQAM.

Accordingly, there is a need in the art for an improved method of data communication to increase data capacity and spectral efficiency as compared to conventional OOK transmission and conventional ASK, PSK, QAM, DPSK, DQAM, and QPSK modulation techniques. There is a further need in the art for a transmitter and a receiver for achieving increased data capacity and spectral efficiency as compared to a conventional transmitter and receiver supporting standard OOK transmission. There is also a need in the art for a multilevel amplitude and phase modulation format that requires less complex circuitry compared to the circuitry needed to support ASK, PSK, QAM, DPSK, DQAM, and QPSK modulation techniques. Another need exists in the art for a communication method that increases spectral efficiency or bandwidth without requiring additional circuitry at a receiver to track the absolute phase of a signal.

### SUMMARY OF THE INVENTION

The present invention combines standard binary ASK modulation with differential PSK (DPSK) modulation to achieve a two times or doubled increase in data throughput and a spectral efficiency of 1 bit/s/Hz. In other words, the present invention can be characterized as overlaying DPSK onto a regular binary ASK transmission. Such a technique constitutes a unique type of multilevel modulation that can be used in principle to aggregate two separate digital data streams or to lower the symbol rate of a single high-speed digital data stream. Each bit generated by the inventive modulation technique can have one of two intensities and one of two phases such that every symbol transmitted can comprise two bits. The present invention encodes (and subsequently decodes) information into both the phase and amplitude of an optical carrier.

With the present invention, and unlike QAM discussed above, the relative phase of a received modulated signal is tracked or monitored instead of the absolute phase. In this way, a local reference phase source in a receiver, such as a local oscillator, can be eliminated. That is, the present invention differs from coherent QAM, which utilizes PSK (as opposed to DPSK) and requires a local oscillator at the receiver to recover the in-phase and quadrature bits. In general, QAM uses at least four distinguishable phase states while the DPSK modulation format utilized by the present invention has only two allowable phase states.

This translates into less complex circuitry and lower costs for a receiver in the inventive system. This also means that phase integrity does not need to be maintained throughout the communications system like that of a coherent QAM communications system. In addition, the conventional QAM transmission systems for fiber optic links utilize amplitude and phase modulation of an intermediate RF carrier, whereas the present invention encodes data directly into the amplitude and phase of the optical carrier. While the present invention is preferably intended for the modulation of signals in the optical domain, one of ordinary skill in the art recognizes that the teachings of the inventive modulation technique could be implemented entirely in the electrical domain without departing from the scope and spirit of the present invention. Such an implementation of the invention would require broadband phase modulation capability in the RF domain which is a less preferred exemplary embodiment of the present invention.

The present invention can also be characterized as binary ASK modulation with additional phase manipulation of the optical carrier to encode a second data stream in the transmitted optical signal without altering the spectrum of the signal. Two OOK electrical data streams (D₁ and D₂) can be combined to form 4 distinct states. These four states are encoded as two amplitudes and two phases within the transmitted symbol. In the alternative, one data stream can be encoded as two intensities (lower intensity must be greater than zero) and D₂ can be encoded in DPSK format. The phase of each optical bit corresponding to D₁ (whether high or low) is modulated according to the DPSK-encoded D₂ data stream. The fact that the D₁ and D₂ modulate the carrier with independent formats enables simplified transmitter and receiver designs.

In this way, D₁ is transmitted via ASK while D₂ is transmitted simultaneously via DPSK. This method of modulation may be applicable to other transmission systems besides photonic links. Other aspects of the invention may combine n-ary ASK modulation with DPSK modulation to further increase aggregate throughput and improve spectral efficiency.

The present invention also exhibits some features of duobinary signaling in that both achieve the same spectral efficiency of 1 bit/s/Hz via phase manipulation of an OOK signal. However, one difference between duobinary signaling and the present invention can be explained as follows. Duobinary signaling maintains the same aggregate throughput as that of an original OOK signal, but phase manipulation of the transmitted optical signal is utilized to compress the optical spectrum by a factor of two in order to achieve a spectral efficiency of 1 bit/s/Hz. With duobinary signaling, no information is transmitted in the phase of the optical carrier.

Meanwhile, the present invention does transmit information in the phase of an optical carrier. Further, the present invention achieves the same spectral efficiency by doubling the aggregate throughput of an OOK transmission signal while maintaining a bandwidth equal to that of the OOK signal.

Similar in spectral efficiency to the current invention, four-level ASK modulation can also be used to achieve a spectral efficiency of 1 bit/s/Hz, by doubling throughput for a given spectrum. However, multilevel ASK modulation incurs a significant OSNR penalty. Without accounting for additional penalties that may stem from receiver bandwidth limitations and/or the linearity and gain flatness of components in the transmission system, the penalties for n-ary ASK are given by the following equations:

Penalty_{OSNR}=2log(2ⁿ−1)

Thus, 4-level signal transmission incurs a 9.5 dB OSNR penalty over OOK modulation at the same base symbol rate while increasing the spectral efficiency to 1 bit/s/Hz. The present invention aims to alleviate some of this incurred OSNR penalty.

According to one exemplary aspect of the present invention, a four-level amplitude and phase modulation format can be implemented with fairly simple circuitry. Specifically, the system for producing four-level modulation can comprise a DPSK precoder, an inverter, summing circuitry, a laser, and a Mach-Zehnder modulator. According to another exemplary aspect of the present invention, the system for receiving and decoding the four-level modulation can comprise an optical splitter, photodetectors, a delay circuit, summing circuitry, and a threshold detector.

Standard digital transmission is often referred to in the art as OOK transmission. It will be known to those of ordinary skill in the art that this modulation format is also referred to as binary ASK as well as intensity modulation-direct detection (IM-DD). While this terminology is often interchangeable in the art, those of ordinary skill in the art will recognize that binary ASK (as opposed to OOK) is a more correct description of the modulation technique utilized by this invention. Since data is encoded into both the phase and amplitude of the carrier, the low amplitude state of the modulation format (corresponding to logic “0”) must actually be an amplitude that is greater than zero since the phase of the signal must also be modulated while the amplitude is at its low state. If the modulation of the amplitude actually utilized a low state with amplitude equal to zero, there would be no carrier phase available for modulation whenever the amplitude modulation transmitted the low state. Hence, the term OOK is not entirely correct with regards to this specific invention since the amplitude modulation never truly reaches the “Off” state. In addition, one of ordinary skill in the art will recognize that for the purposes of the teachings of this invention, intensity modulation and amplitude shift keying are synonymous.

### BRIEF DESCRIPTION OF THE DRAWINGS

FIG. 1 is a constellation diagram illustrating the amplitude and the phase of an allowed set of transmitted symbols for the conventional QAM format.

FIG. 2A is another constellation diagram for a conventional four level scheme implemented exclusively with phase modulation which is generally referred to as multi-level PSK.

FIG. 2B illustrates a conventional QPSK transmitter corresponding to the constellation shown in FIG. 2A.

FIG. 2C illustrates a conventional QPSK receiver.

FIG. 3 illustrates exemplary waveforms of other conventional modulation techniques such as multilevel ASK and DPSK techniques.

FIG. 4A illustrates a transmitter constructed in accordance with one exemplary embodiment of the present invention.

FIG. 4B illustrates a transmitter that utilizes separate optical intensity and phase modulators constructed in accordance with an alternate exemplary embodiment of the present invention.

FIG. 5 illustrates a receiver that does not require a reference phase source and that is constructed in accordance with an exemplary embodiment of the present invention.

FIG. 6 is a constellation diagram illustrating the amplitude and the phase of one exemplary embodiment of the present invention.

FIG. 7 illustrates exemplary waveforms produced according to one exemplary embodiment of the present invention.

FIG. 8 illustrates a transmitter that utilizes a directly modulated laser and a separate phase modulator constructed in accordance with an alternate exemplary embodiment of the present invention.

FIG. 9 illustrates a receiver that utilizes two photodetectors constructed in accordance with an alternate exemplary embodiment of the present invention.

### DETAILED DESCRIPTION OF EXEMPLARY EMBODIMENTS OF THE INVENTION

The present invention supports data transmission that uses simultaneously the amplitude and phase of a carrier to effectively double the capacity and spectral efficiency compared to standard OOK transmission. As such, the exemplary embodiments include a transmitter and receiver capable of encoding and decoding, respectively, two independent data streams using the amplitude and phase of an optical carrier. It will be obvious to one of ordinary skill in the art that the two independent data streams may in fact be demultiplexed from a single higher-speed data stream to reduce the transmitted symbol rate.

Referring now to the drawings, in which like numerals represent like elements throughout the several Figures, aspects of the present invention and the illustrative operating environment will be described.

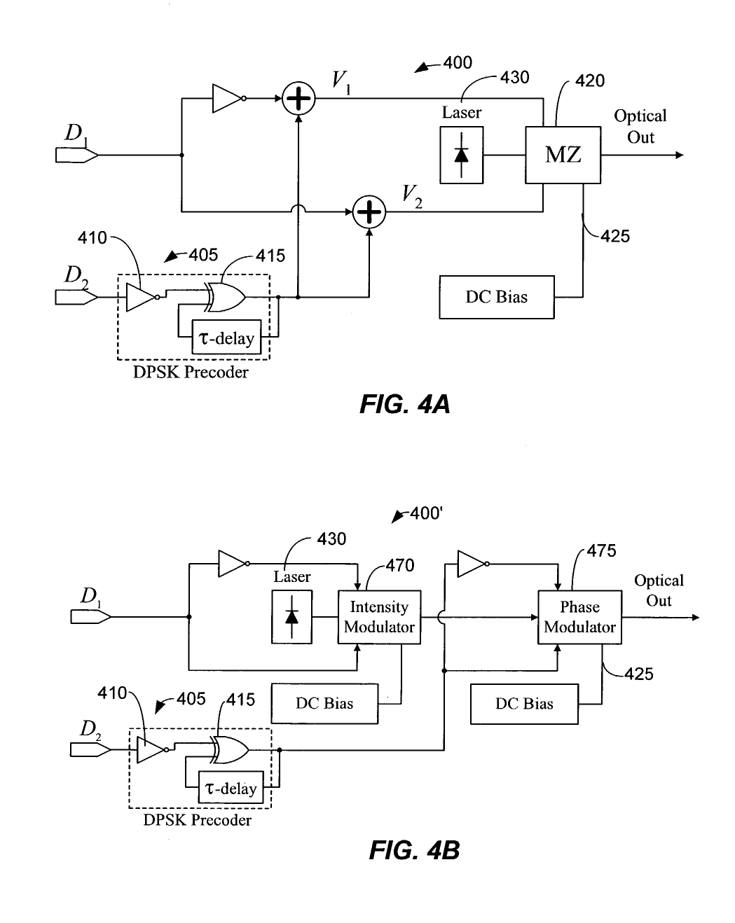

Referring now to FIG. 4A, to accomplish the optical transmission of two independent data streams using the amplitude and phase of an optical carrier, the first data stream, D₁, should be used to modulate the optical intensity of the optical carrier between a high and low state (high corresponding to a “1” in D₁ and low corresponding to a “0”). While FIG. 4A depicts an optical transmitter 400, one of ordinary skill in the art recognizes that the teachings of the inventive modulation technique could be implemented entirely in the electrical domain without departing from the scope and spirit of the present invention.

Since the phase of the optical carrier of the present invention must be modulated as well as the amplitude, the low optical intensity state usually must be greater than zero. The second data stream, D₂, is encoded for DPSK of the optical carrier. This encoding technique will be well known to those skilled in the art. According to this technique, the phase of the optical carrier is differentially modulated according to the bit values of D₂ such that a constant phase between two consecutive symbol slots represents a “1” while a π-phase shift between two consecutive bit slots represents a “0.”

This means that the relative phase of the encoded signal will be tracked, which is opposite to coherent QAM that tracks the absolute phase of an encoded signal. The modulation technique of the present invention is easily accomplished using a precoder 405 for D₂ that comprises an inverter 410 and an XOR gate 415.

An exemplary precoder 405 for D₂ is illustrated in FIG. 4A. D₂ is input to the inverter 410, the output of which is one of two inputs to the XOR gate 415. The second input to the XOR gate 415 is the output of the XOR gate 415 for the previous bit cycle. The output of the XOR gate 415, D₂′, is encoded for DPSK transmission. The process is summarized below:

| | |
|---|---|
| D₂: | 0 1 1 0 1 0 0 0 1 0 1 1 1 1 0 1 0 0 1 1 1 0 0 |
| \overline{D₂}: | 1 0 0 1 0 1 1 1 0 1 0 0 0 0 1 0 1 1 0 0 0 1 1 |
| D₂′: | 1 1 1 0 0 1 0 1 1 0 0 0 0 0 1 1 0 1 1 1 1 0 1 |

Optical carrier phase difference between two consecutive symbols: (0) π π π 0 0 π 0 π π 0 0 0 0 0 π π 0 π π π π 0 π (where the delay circuit is assumed to be initialized with a “0”.)

One skilled in the art will recognize that the two independent digital data streams, D₁ and D₂, may originate as being the two demultiplexed outputs of a single higher speed digital data stream. Such implementations are common for bandwidth-limited channels where the serial data rate of the original single data stream exceeds the bandwidth-distance limitations of the channel.

FIG. 4A illustrates an exemplary embodiment of a transmitter 400 designed to modulate two separate data streams, D₁ and D₂, onto an optical carrier using both the amplitude and phase of the optical carrier. The independent data streams D₁ and D₂′ can be combined as electrical signals to simultaneously drive both electrodes of a single optical Mach-Zehnder (MZ) modulator 420 in such a way that the optical intensity is modulated with D₁ while the optical phase is modulated with D₂′. The MZ 420 modulates a continuous wave laser 430. The laser 430 can comprise a distributed feed back laser. However, other types of lasers are not beyond the scope and spirit of the present invention.

One skilled in the art will recognize that the specific method of combining D₁ and D₂′ (along with any required DC biases) to properly drive the MZ 420 will depend on the specific characteristics of the MZ 420 such as V_{π} (the voltage difference between electrodes that induces a π phase shift on the optical carrier) as well as the phase sense of the two optical paths with respect to each other (positive or negative).

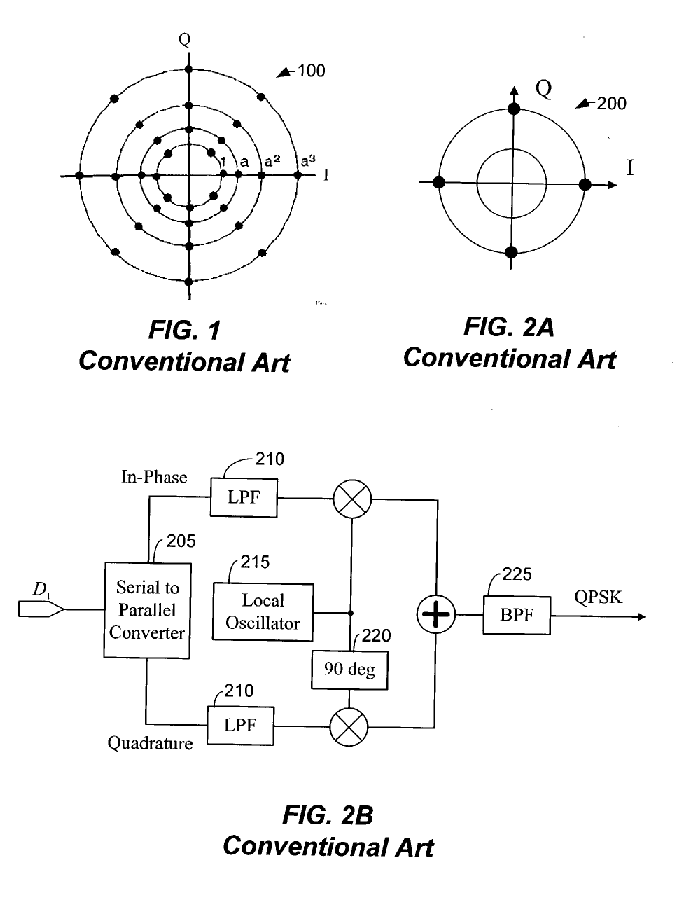

An exemplary method of combining D₁ and D₂′ is illustrated in FIG. 4A where the two optical paths of the MZ 420 are assumed to have a positive phase sense (i.e., for a given applied voltage to one arm of the MZ 420, the resulting phase change of the optical signal passing through that arm is the same sign as a similarly induced phase change on the other arm) with respect to each other. Each arm of the MZ 420 is driven by a separate 4-level electrical signal, V₁ and V₂ The lower arm 425 of the MZ 420 is also biased with a DC bias equal to −0.25·V_{π}. The 4-level signal V₁ is generated by summing \overline{D₁} and D₂′. The 4-level signal V₂ is generated by summing D₁ and D₂′. The peak-to-peak voltage swings of both V₁ and V₂ should be equal to V_{π}, which may require an electrical amplifier for each data stream (not shown in FIG. 1). In addition, to achieve a 4-level output from each of the summers shown in FIG. 4A, the inputs to the summers must have different peak-to-peak voltages. An exemplary embodiment comprises D₂′ having an amplitude that is two times greater than that of D₁. In practice, this can be achieved with a simple attenuator, not shown in the figure. The table below summarizes the encoding and modulation functions of the transmitter in FIG. 4A (V₁ and V₂ are normalized to V_{π}).

Summary of Exemplary Transmitter 400 Performance as Shown in FIG. 4

| | | | | Optical Intensity | Optical Phase |
|---|---|---|---|---|---|
| D₁ | D₂′ | V₁* | V₂* | (MZ output)** | (MZ output) |
| 0 | 0 | 0.25 | 0 | Low | 0 |
| 1 | 0 | 0 | 0.25 | High | 0 |
| 0 | 1 | 0.75 | 0.5 | Low | π |
| 1 | 1 | 0.5 | 0.75 | High | π |

*Normalized to V_{π} of the MZ modulator.
**In a typical embodiment, the optical intensities (normalized to maximum intensity) would be 1 and 0.5 for the high and low states respectively.

There is an optimized choice for the amplitude levels which balances the SNR of the decoded ASK and DPSK channels. Furthermore, it is clear that this method may be extended to more amplitude and phase states. The optimized choice for amplitude levels is represented by the values in the table above. For the case of increased amplitude levels, n data streams can be combined electrically (using an adder or a DAC) to form a first 2ⁿ-level electrical signal. Simultaneously, the inverses of the n data streams can be combined electrically into a second 2ⁿ-level electrical signal. Each of these multilevel amplitude signals is combined with the same DPSK-encoded data stream (the n+1 data stream) so that the electrical multilevel signals both have 2⁽ⁿ⁺¹⁾ levels.

Each of these multilevel data streams is input to one of the electrode arms of the MZ modulator 420 to generate a 2ⁿ-level optical signal with the phase of the optical symbols carrying the DPSK-encoded data stream. As an extension, m data streams could be combined into a 2^{m}-level DPSK-encoded electrical signal.

One skilled in the art will recognize that this same modulation method could be accomplished using two separate modulators. In this scenario, D₁ would modulate a optical intensity modulator, the output of which would be input to an optical phase modulator driven by D₂′. The resulting optical signal would be intensity modulated by D₁ between high and low intensity states and DPSK modulated by D₂′.

Referring now to FIG. 4B, this Figure illustrates such an exemplary embodiment where the transmitter 400′ utilizes separate optical intensity and phase modulators 470, 475. Each of the modulators 470, 475 illustrated in this alternate exemplary embodiment is driven differentially, although one skilled in the art will recognize that a similar embodiment (not shown) could comprise single-ended components. In addition, if the digital data streams are differential, the two inverters (one for each modulator 470, 475) would not be required to drive the modulators differentially.

As illustrated in the embodiment illustrated in FIG. 4B, the first digital data stream, D₁, is used to modulate the intensity of an optical carrier, while the second digital data stream, D₂, is DPSK-encoded and used to differentially modulate the phase of the optical carrier. The DC Biases for each of the modulators 470, 475 will depend on the specific characteristics of the modulators 470, 475 used and may not even be necessary.

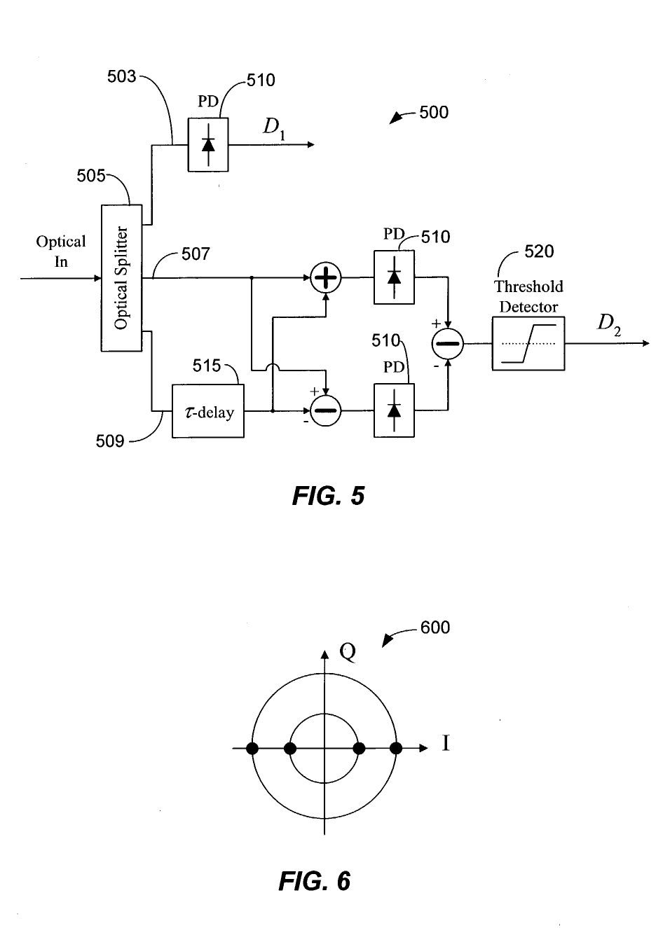

Referring now to FIG. 5, this Figure illustrates an exemplary embodiment of a receiver 500 designed to recover the data streams D₁ and D₂ from the received optical signal without the need of a reference phase source such as an oscillator. While FIG. 5 depicts an optical receiver 500, one of ordinary skill in the art recognizes that the teachings of the inventive modulation technique could be implemented entirely in the electrical domain without departing from the scope and spirit of the present invention.

The received optical signal is input to an optical power splitter 505 with three outputs. A first output comprising a first optical path 503 is directly detected by a first photodetector (PD) 510. The output electrical signal from this first PD 510 is D₁. The remaining two outputs of the splitter are used to recover the phase-encoded bits, D₂. One of these two remaining outputs comprises a second optical path 509 that is delayed with a delay circuit 515. The delay circuit 515 delays the second optical path 509 with respect to the other third optical path 507 by one bit period (r).

The delayed optical signal of the second optical path 509 is simultaneously added to the non-delayed signal of the third optical path 507 while the non-delayed signal of the third optical path 507 is subtracted from the second optical path 509 after the delay circuit 515. Each of the resulting optical signals is input to a separate PD 510 that converts the optical signal into an electrical signal. The electrical signal of the second optical path 509 is subtracted from the electrical signal corresponding to the third optical path 507. The resulting waveform is a 4-level electrical signal.

In order to recover D₂, the 4-level signal is input to a threshold detector 520 that can comprise a standard OOK decision-making circuit, where the decision threshold is set to the center of the lowest eye of the detected signal. All bits (those corresponding to the lowest level) below this threshold are interpreted as a “0”, while all bits above this threshold (all levels besides the lowest level) are interpreted as a “1.” In this manner, D₂ is extracted from the received optical signal. One skilled in the art will recognize that the delay circuit 515 and the optical addition and subtraction functions can be accomplished using an optical interferometer with one path of the interferometer delayed with respect to the other path by T in order to achieve the required delay of one bit cycle period.

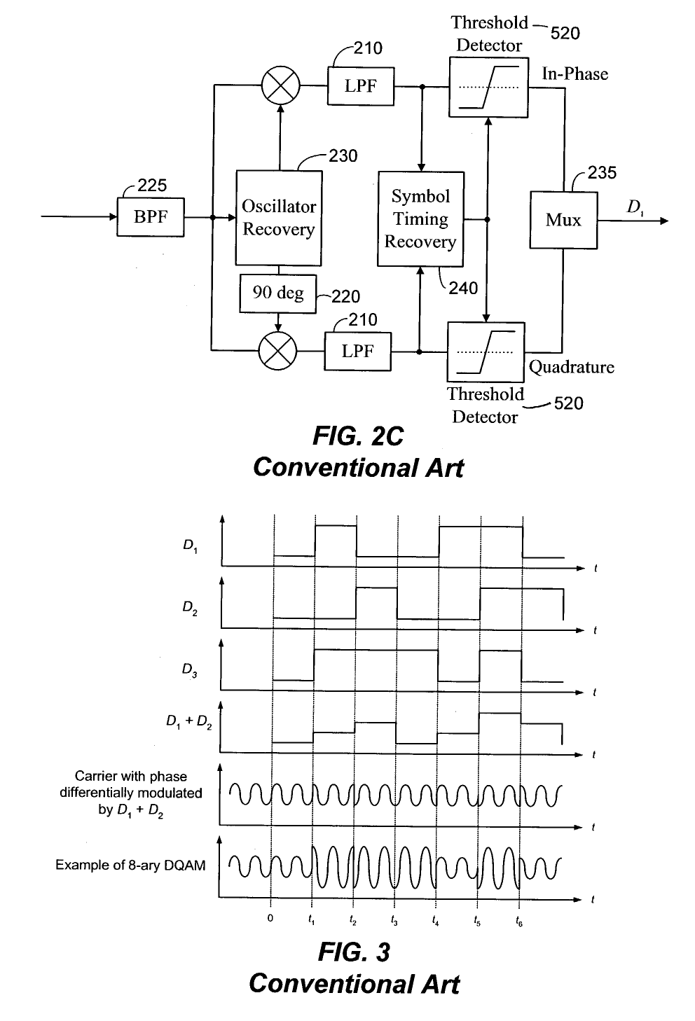

Referring now to FIG. 6, this Figure illustrates a constellation diagram 600 illustrating an amplitude and phase modulated signal format with four possible states, or levels. More specifically, the constellation diagram 600 illustrates how a signal modulated according to the present invention can comprise two amplitudes and two phases. FIG. 6 can be compared and contrasted with FIG. 2 of the conventional art. Opposite to FIG. 6, FIG. 2 illustrates one amplitude and four phases that is produced by a multilevel PSK format of the conventional art.

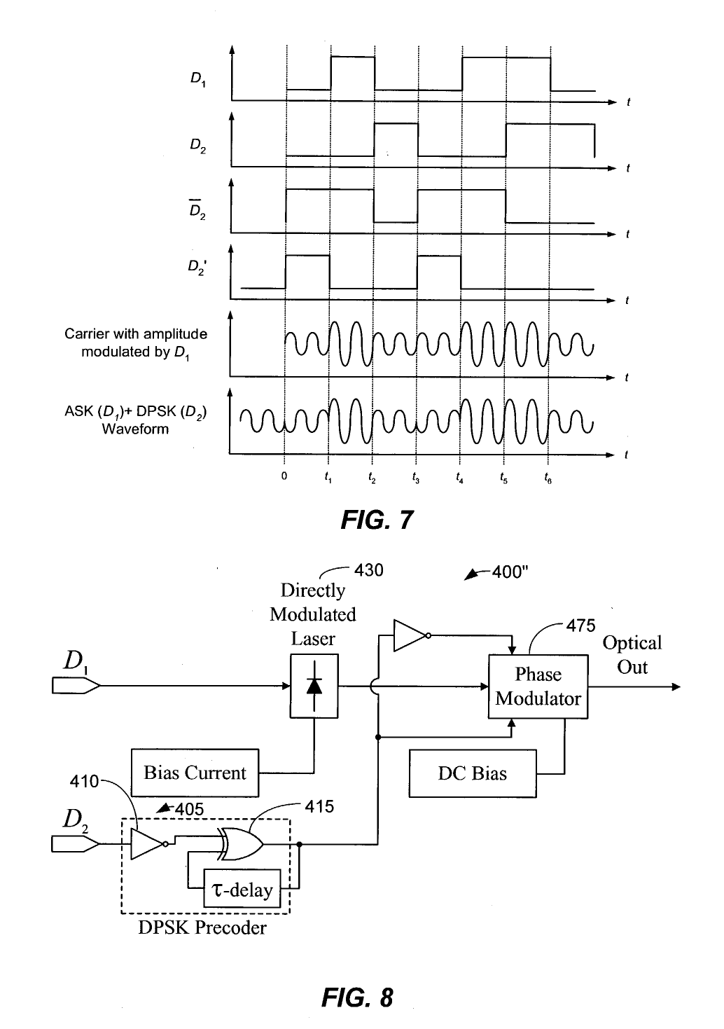

Referring now to FIG. 7, this Figure illustrates exemplary waveforms produced according to one exemplary embodiment of the present invention that can be compared and contrasted to the conventional waveforms illustrated in FIG. 3. Two digital data streams (D₁ and D₂) are encoded simultaneously into the phase and amplitude of a carrier that can comprise an RF or optical carrier. The amplitude of the carrier is modulated according to D₁, while the phase of the carrier is modulated differentially according to D₂. In order to achieve the differential phase modulation, D₂ is first inverted. The inverted D₂ is then input to an XOR gate 415 (with the second input to the XOR gate 415 being the output of the XOR gate 415 from the previous clock cycle). This encoder 405 is illustrated in the transmitter 400 embodiment shown in FIG. 1. The output of the XOR is D₂′. This waveform is used to differentially modulate the phase of the carrier.

Referring now to FIG. 8, this Figure illustrates an exemplary embodiment of the transmitter 400″ that utilizes a directly modulated laser and a separate optical phase modulator 475. The phase modulator 475 illustrated in this embodiment is driven differentially, although one skilled in the art will recognize that a similar embodiment (not shown) could comprise a single-ended modulator. In addition, if the digital data stream, D₂, is differential, the inverter would not be required to drive the phase modulator differentially.

As in the embodiment illustrated in FIG. 4B, the first digital data stream, D₁, is used to modulate the intensity of an optical carrier, although in this embodiment the intensity modulation is accomplished via the direct modulation of a laser. The second digital data stream, D₂, is DPSK-encoded and used to differentially modulate the phase of the optical carrier. The DC Bias for the phase modulator will depend on the specific characteristics of the modulator used and may not even be necessary.

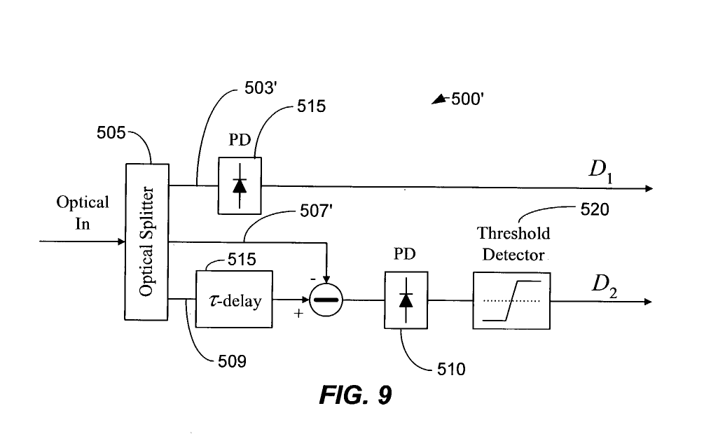

Referring now to FIG. 9, this Figure illustrates an exemplary embodiment of a receiver 500′ that utilizes two photodetectors 510 as opposed to the embodiment illustrated in FIG. 5 that used three photodetectors 510. The embodiment in FIG. constitutes a preferred embodiment since the phase encoded data is recovered via a balanced detector topology that includes two photodetectors 510 and improves signal-to-noise-ratio (SNR). The embodiment shown in FIG. 9 represents a subset of the preferred embodiment of FIG. 5, in that the balanced topology is eliminated for a simpler implementation which requires a total of two (rather than three) photodetectors 510. The received optical signal is input to a splitter 505 that splits the signal into three distinct paths. The first path 503′ is directly input to a photodetector 510. The output electrical signal from this first photodetector 510 corresponds to the digital data stream, D₁, used to modulate the intensity of the optical carrier.

The remaining two outputs from the optical splitter are used to extract the DPSK-encoded digital data stream, D₂. The second optical path 509′ (output from the splitter 505) is delayed temporally by one bit period relative to the third optical path 507′ via a delay circuit 515. The optical signal from the third path 507′ is the subtracted from that of the second path 509′, and the resulting difference is input to a second photodetector 510. A threshold detector 520 can be used to extract the digital data stream, D₂, from the resulting four level electrical signal by making a decision based on the center eye opening of the multilevel eye. In practice, the delay circuit 515 and subtract function can be accomplished with an optical interferometer (not shown).

In view of the foregoing, it will be appreciated that the present invention provides a method of optical transmission that achieves a spectral efficiency of 1 bit/s/Hz with direct detection at the receiver. The incurred OSNR penalty associated with the method of the present invention is less than that compared to n-ary ASK. Since the present invention maintains the spectrum of an OOK transmission of the same symbol rate while doubling the throughput (compared to the OOK transmission), the spectral efficiency achieved with the current invention is twice that of standard OOK. The spectral efficiency of an OOK signal is 0.5 bit/s/Hz, while the current invention enables data transmission with a spectral efficiency of 1 bit/s/Hz.

In summary, the present invention enables two bits per symbol that can be processed with a direct detection based receiver. The inventive modulation technique allows for a simplified transmitter 400, compared to transmitters of conventional full QAM or DPSK modulation techniques. Specifically, according to one exemplary embodiment, the inventive modulation can be performed with one dual-drive Mach-Zehnder modulator 420 as illustrated in FIG. 4. According to another exemplary embodiment, the inventive modulation can be performed with a directly modulated optical source and a separate phase modulator as illustrated in FIG. 8, discussed above. According to another exemplary embodiment, the inventive modulation can be performed with separate amplitude modulator and phase modulator as illustrated in FIG. 4B, discussed above.

Similarly, the inventive modulation technique allows for a simplified receiver 500, compared to receivers of conventional full QAM or DPSK modulation techniques. For example, according to one exemplary embodiment, the inventive demodulation can be performed with a receiver comprising three detectors 510 as illustrated in FIG. 5: two detectors 510 for the differentially phase modulated data stream and one detector 510 for the amplitude modulated data stream. According to an alternate exemplary embodiment, the inventive demodulation can be performed with two detectors 510 where one is used for the differentially phase modulated data stream and the other is used for amplitude modulated data stream as illustrated in FIG. 9, discussed above.

It should be understood that the foregoing relates only to illustrate the embodiments of the present invention, and that numerous changes may be made therein without departing from the scope and spirit of the invention as defined by the following claims.

What is claimed is:

1. A method for high speed communications comprising:
receiving a first and second data streams;
modulating an amplitude of a carrier signal with the first data stream between a first state and a second state, the first state comprising a magnitude greater than the second state; and
differentially modulating the carrier signal according to bit values of the second data stream such that a constant phase between two consecutive bit slots represents a first value while a phase shift of a predetermined magnitude represents a second value different from the first value.

2. The method of claim 1 wherein differentially modulating the carrier comprises a differential phase shift keying (DPSK) modulation technique.

3. The method of claim 1, wherein modulating an intensity of the carrier comprises an amplitude shift keying (ASK) modulation technique.

4. The method of claim 1, wherein the carrier signal comprises an optical carrier signal.

5. The method of claim 1, further comprising propagating the carrier signal along an optical waveguide.

6. The method of claim 1, wherein the carrier signal comprises an electrical carrier signal.

7. The method of claim 1, further comprising propagating the carrier signal along an electrical waveguide.

8. The method of claim 1, further comprising:
receiving one data stream; and
dividing the one data stream into the first and second data streams.

9. The method of claim 1, further comprising propagating the carrier signal along a waveguide.

10. A transmitter for generating multilevel signals comprising:
a circuit for overlaying a first data stream comprising a differential phased shift keyed signal onto a second data stream comprising a binary amplitude shift keyed signal, wherein each bit of a resultant data stream comprises one of two amplitudes and one of two phases such that each symbol of the signal comprises two bits of data.

11. The transmitter of claim 10, wherein the circuit further comprises an inverter for inverting the second data stream.

12. The transmitter of claim 10, wherein the circuit further comprises a precoder for processing the first data stream.

13. The transmitter of claim 12, wherein the precoder comprises an inverter, an XOR gate, and a delay circuit.

14. The transmitter of claim 10, wherein the first data stream is added with a portion of the second data stream.

15. The transmitter of claim 10, wherein the circuit comprises a Mach-Zehnder modulator coupled to the first and second data streams and coupled to a laser.

16. A receiver for decoding multilevel signals comprising:
a splitter for dividing a received multilevel signal into a plurality of paths;
a first signal detector coupled to a first path for detecting a first data stream;
a delay circuit coupled to a second path;
a second signal detector coupled to the second path downstream from the delay circuit;
a third signal detector coupled to a third path; and
a threshold detector coupled downstream from the delay circuit, wherein the receiver tracks a relative phase of the received multilevel signal.

17. The receiver of claim 16, wherein the receiver decodes information from both a phase and an amplitude of the multilevel signal.

18. The receiver of claim 16, wherein the splitter comprises an optical splitter and the signal detectors comprise photodetectors.

19. The receiver of claim 16, wherein a delayed signal of the second path is added to the third path, and a non-delayed signal of the third path is subtracted from the second path.

20. The receiver of claim 16, further comprising an interferometer for adding a delayed signal of the second path to the third path, and for subtracting a non-delayed signal of the third path from the second path.

21. A transmitter for generating multilevel signals comprising:
a first data stream comprising an binary amplitude shift keyed signal for modulating a carrier source, the carrier source generating a carrier signal;
a second data stream comprising a differential phased shift keyed signal that is fed into a phase modulator, the phase modulator for differentially modulating a phase of the carrier signal, wherein each bit of a resultant multilevel signal comprises one of two intensities and one of two phases such that each symbol of the mulitlevel signal comprises two bits of data.

22. The transmitter of claim 21, further comprising an intensity modulator coupled to the carrier source.

23. The transmitter of claim 21, wherein the carrier source comprises a laser.

24. The transmitter of claim 21, further comprising a precoder for producing the differential phased shift keyed signal.

25. A receiver for decoding multilevel signals comprising:
a splitter for dividing a received multilevel signal into a plurality of paths;
a first signal detector coupled to a first path for detecting a first data stream;
a delay circuit and a second signal detector coupled to a second path;
a third path that is subtracted from the second path; and
a threshold detector coupled to the second path for detecting a second data stream, whereby said receiver is balanced and substantially improves a signal-to-noise ratio.

26. The receiver of claim 25, wherein each signal detector comprises a photodetector.

27. The receiver of claim 25, wherein the threshold detector comprises a decision-making circuit.
